(19) United States
(12) Patent Application Publication
(10) Pub. No.: US 2011/0091143 A1
(43) Pub. Date: Apr. 21, 2011

(54) SPHERICAL BEARING TRIPLE-LIP SEAL

(75) Inventors: Timothy P. Murphy, Canton, OH (US); Liviu V. Anton, Ploiesti (RO); Ioana C. Savin, Ploiesti (RO); Richard Borowski, Canton, OH (US); Mark Esposito, North Canton, OH (US)

(73) Assignee: THE TIMKEN COMPANY, Canton, OH (US)

(21) Appl. No.: 12/992,315

(22) PCT Filed: May 28, 2009
(86) PCT No.: PCT/US2009/045451

§ 371 Date: Nov. 12, 2010

Related U.S. Application Data
(60) Provisional application No. 61/056,574, filed on May 28, 2008.

(51) Int. Cl. F16C 33/76; F16J 15/32; F16C 19/02

(52) U.S. Cl. 384/473; 277/563; 277/551

(57) ABSTRACT

A seal component (100, 200) having a triple-lip configuration for sealing against a moving surface, such as the inner ring race surface (12, 12′) of a spherical plain bearing (14, 14′). The triple-lip configuration incorporates a pair of outward inclined seal lips (102, 202, 104, 204) for providing protection from external contaminates, and a third inwardly inclined seal lip (106, 206) which is orientated to provide lubricant or grease retention within the sealed bearing (14, 14′). The size and configuration of the third seal lip (106, 206) is selected to minimize surface friction and to avoid seal lip inversion during oscillatory motion of the bearing components during use. A retention surface (110a, 210) is disposed to abut against the outer ring race surface (10b, 10b) to resist roll-out displacement of the seal component (100, 200) during use.

### CROSS-REFERENCE TO RELATED APPLICATIONS

The present application is related to, and claims priority from, U.S. Provisional Patent Application Ser. No. 61/056,574 filed on May 28, 2008, and which is herein incorporated by reference.

### STATEMENT REGARDING FEDERALLY SPONSORED RESEARCH

Not Applicable.

### BACKGROUND OF THE INVENTION

The present invention is related generally to bearing seals, and in particular, to a triple-lip seal for use with a spherical bearing assembly such as a sealed spherical plain bearing.

Sealed spherical plain bearings are predominantly used in construction and mining applications, and have dimensions which are standardized by ISO 12240 and ABMA 22.2 to facilitate mechanical design, support manufacturing efficiency, and promote interchangeability between manufacturers. The spatial constraints of maintaining standardized envelope dimensions, combined with seal installation, often require a reduction in the area available for bearing contact surfaces. The most common damage mode observed in or on these bearing contact surfaces in construction and mining environments is abrasive and adhesive wear at the race contact surfaces. Existing commercially available seals for sealed spherical plain bearings incorporate both single and double lip seals, such as shown in FIGS. 1 and 2, with the seal lips oriented outward along the surface of the bearing inner ring race to prevent contamination ingress. Conventional seals may include configurations having an internal stiffening ring or member within an annular seal body.

In addition to harsh environmental conditions, sealed spherical plain bearing assemblies must withstand application loading and machine/vehicle positioning which can cause significant housing deflections. These deflections are transmitted to the outer ring of the bearing and often compromise the retention features of the seals. Traditional seals, such as shown in FIGS. 1 and 2, are commonly retained with an interference fit between the seal OD and the outer ring seal groove. A radial interference between seal OD and seal groove diameter is used in some designs while others use an axial interference between the seal width and outer ring seal groove (see FIG. 1). Adhesives and/or plastic deformation of the seal groove material (otherwise known as staking) against the seal's outer diameter have also been utilized for seal retention. Due to deflections of the housing, and consequent outer ring deflections, combined with the moment loads generated by the seal drag during bearing oscillations, contamination ingress and loss of seal retention is not uncommon.

The seal shown in FIGS. 1 and 2 is comprised of three surfaces which make point contact with the inner ring or inner race surface. Because of the point contact of the seal with the inner race, the deflection of the seal, resulting from movement of the outer race relative to the inner race, could result in a discontinuity in seal contact, thereby allowing contaminants into the bearing assembly or allowing lubricant to escape the bearing assembly.

Accordingly, it would be advantageous to provide a spherical plain bearing assembly with a seal component which is capable of maintaining an adequate seal between the inner and outer ring race surfaces during outer ring deflections and bearing oscillations, and which provides improved sealing functionality together with lubricant retention. It would be further advantageous to provide such a seal component without compromising bearing load capacity or altering standardized dimensions.

### BRIEF SUMMARY OF THE INVENTION

Briefly stated, the present disclosure provides a seal component carried by an outer ring race and having a triple-lip configuration for sealing against a moving surface, such as the inner ring race surface of a spherical plain bearing. The triple-lip configuration of the seal component incorporates a pair of outward inclined seal lips for providing protection from external contaminates, and a third inwardly inclined seal lip which is orientated to provide lubricant or grease retention within the sealed bearing. The size and configuration of the third seal lip is selected to minimize surface friction and to avoid seal lip inversion during oscillatory motion of the bearing components during use.

In accordance with one aspect, the seal component is further provided with an outwardly projecting flange shoulder configured to abut the surfaces of the outer ring and prevent “roll-out” of the seal from a retention groove within the outer ring in response to inner ring rotational movement.

In another aspect, the inboard side of the seal has a diameter sized to facilitate centering of the seal in the outer ring during installation. The outboard face of the seal was designed with a planar surface to facilitate uniform installation of the seal into the bearing.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a sectional view of a prior art double-lip seal positioned in a bearing assembly;

FIG. 2 is an enlarged sectional view of the prior art double-lip seal of FIG. 1;

FIG. 3 is a sectional view of a triple-lip seal of the present disclosure, incorporating a retaining flange;

FIG. 4 is a sectional view of the triple-lip seal of FIG. 3 positioned in a bearing assembly;

FIG. 5 is a sectional view of an alternative embodiment of the triple lip seal, incorporating a retaining flange; and

FIG. 6 is a sectional view of the triple-lip seal of FIG. 5 positioned in a bearing assembly.

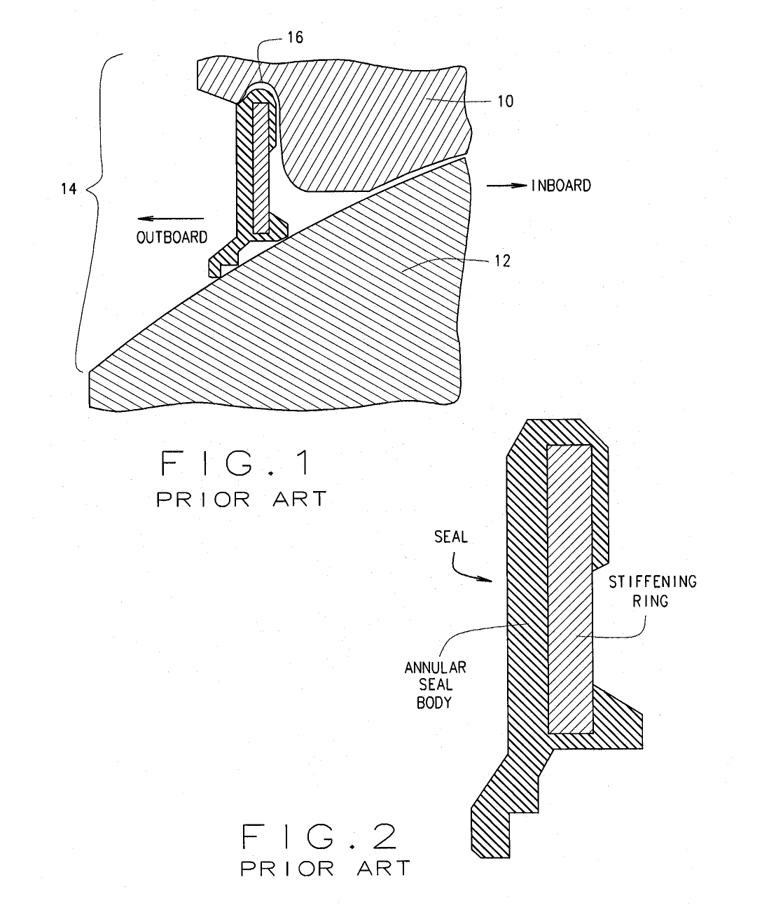

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

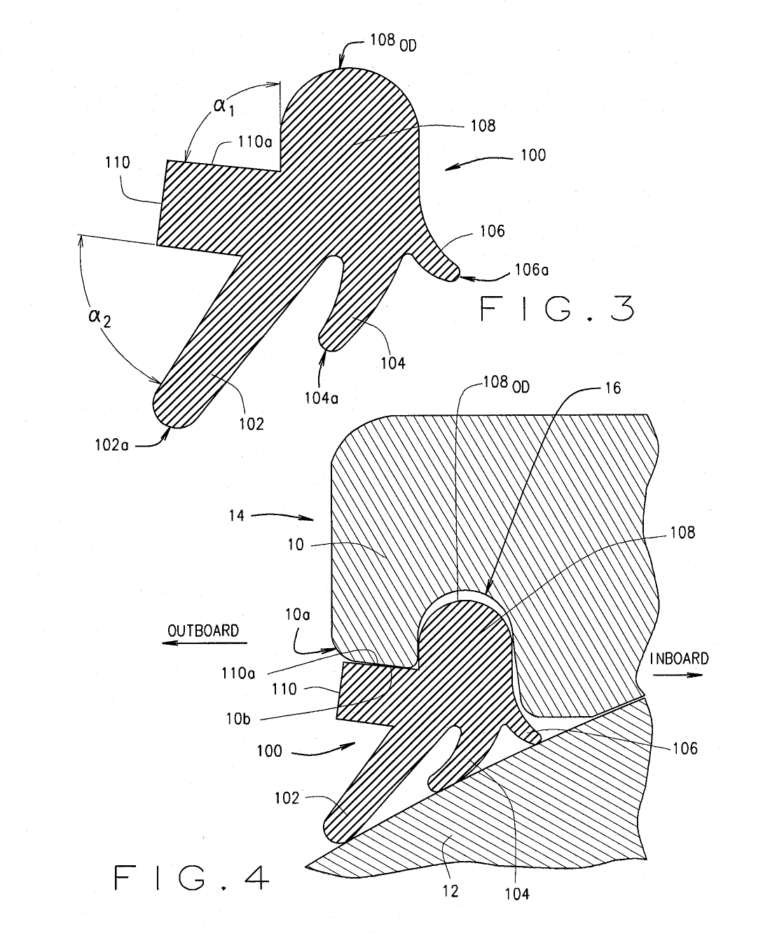

Turning to the figures, and to FIGS. 3 and 4 in particular, a seal component 100 of the present disclosure is shown for application between the outer race 10 and an inner race 12 of a bearing assembly 14, such as a spherical plain bearing. Generally, the seal component 100 of the present disclosure is formed from a homogenous resilient material, and includes two outboard resilient seal lips 102 and 104 that provide protection from contamination. A third (inboard) resilient seal lip 106 is oriented to maximize grease retention within the internal spaces of the bearing assembly 14. The third seal lip 106 minimizes adhesive wear, decreases re-lubrication intervals, and results in an extended bearing service life. In view of the resiliency of the seal lips 102, 104 and 106, movement of the outer race and inner race relative to each other will not result in deflection of the seal that would cause the seal lips to break engagement with the bearing inner race 12.

The seal component 100 is comprised of an annular seal body 108, which may be composed of any suitable material, such as a thermoplastic, selected for use in the application environment. For example, the material can be a thermoplastic elastomer (TPE) such as sold by Ticona under the name RiteFlex® or by DuPont under the name Hytrel®. The annular seal body 108 has a projection or an outer diameter 108_{0D} which is configured for retention in a corresponding seal retention groove 16 in the surface of the outer ring 10, as seen in FIG. 4. Retention of the seal component 100 within the seal retention groove 16 may be by an interference fit alone, and/or may optionally include the use of suitable adhesives. Preferably, the material of the seal component body 108 elastically deforms during installation, and complies with surface variations in the rings.

To prevent the ingress of contaminates from the outboard (external) environment into the sealed inboard (internal) environment of the bearing assembly 14, the first and second seal lips 102, 104 of the seal body 108 project generally outwardly from the seal body 108, and are configured to resiliently engage the surface of the inner ring race 12. Each of the first and second seal lips 102, 104 has a cross-sectional length which exceeds the associated cross-sectional width, to define an elongated extension from the annular seal body 108. The material stiffness, lubricity characteristics, and contact angle of the first and second outboard seal lips 102, 104 result in an interference fit that will not invert while the surface of the inner ring 12 displaces during the application. However, as noted above, the resiliency of the seal lips 102, 104 will maintain the seal lips in sealing contact with the inner race 12 as the seal lips wear or due to movement of the inner and outer races relative to each other. The first and second outboard seal lips 102, 104 are further configured with curved tips 102a, 104a which minimize seal drag while maximizing the contact surface are in engagement with the surface of the inner ring race 12.

To facilitate the retention of lubricants, such as grease, within the sealed bearing assembly 14, the third lip 106 of the seal component seal body projects inward from the seal body 108 and is configured to resiliently engage the surface of the inner ring race 12. The third seal lip 106 has a cross-sectional length which is dimensioned to obtain suitable stiffness characteristics to prevent inversion of the third seal lip 106 upon installation of the seal component 100, and while in use. As with the first and second seal lips 102, 104, the cross-sectional length to width ratio of the inboard (third) seal lip 106 and the mechanical properties of the seal body 108 material create the rigidity needed to prevent the third seal lip 106 from inverting during oscillatory motion of the inner and outer bearing components. However, as noted above, the resiliency of the seal lip 106 will maintain the seal lip in sealing contact with the inner race 12 as the seal lip wears or due to movement of the inner and outer races relative to each other. Additionally, the installed bore dimension and contact angle of the inboard (third) seal lip 106 provides an interference fit at the interface between the tip 106a of the third seal lip and the inner ring race 12 spherical outer diameter to minimize lubricant or grease purge from within the sealed bearing assembly 14.

A retention (or anti-rotation) flange 110 extends outwardly from the seal body 108 to inhibit rotation of the seal body 108 during movement between the inner race 12 and outer race 10 of the bearing assembly 14. The seal body 108 may be provided with the retention flange 110, as seen in FIGS. 3 and 4. The retention flange 110 is disposed to extend outward from the seal body 108 and includes an upper surface 110a which abuts against an inner surface 10b of the outer race 10. Preferably, the retention flange 110 has a generally rectangular cross-section, and is orientated at an acute angle α₁ of less than 90° relative to the seal body 108, and at a second acute angle α₂ between 45° and 80° relative to the first seal lip 102. The retention flange 110 is configured to dynamically react to clockwise moment forces (with respect to the Figures) generated by a seal drag friction force on the seal lips 102 and 104 due counter-clockwise movement (with respect to the Figures) of the inner race 12, to resist oscillation, and to thereby preventing a “roll-out” of the seal body 100 from the outer ring seal retention groove 16.

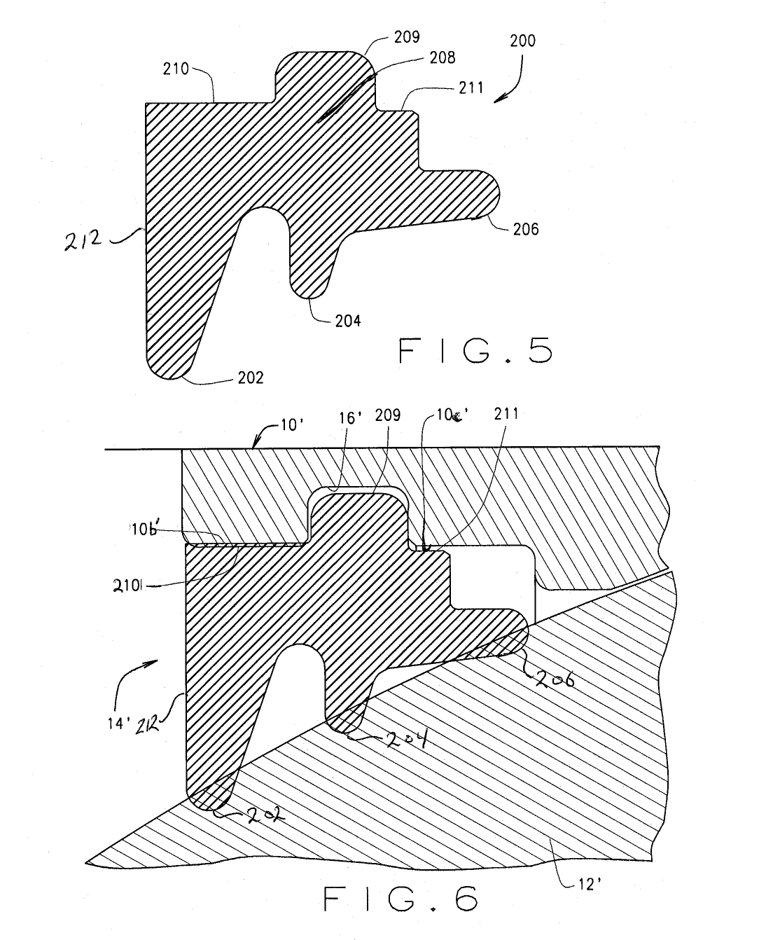

Turning to FIGS. 5 and 6, an alternative embodiment 200 of the seal is shown. The seal 200 is generally similar to the seal 100, and includes a seal body 208, a projection 209 which is received in a retention groove 16′ of the bearing outer race 10′. Three resilient seal lips 202, 204 and 206 extend from the seal body 208 to resiliently engage, and seal against, the bearing inner race surface 14′. The seal lips 202 and 204 extend generally radially, whereas the inner lip 206 extends generally axially. The seal lips 202, 204 and 206 all have a length such that the lips will be deflected upon assembly of the seal 200 into the bearing 14′. In FIG. 6, the seal lips 202, 204 and 206 are drawn as extending into the bearing inner race surface 12′. As can be appreciated, the seal lips will not penetrate the inner race surface 12′. Rather, FIG. 6 demonstrates the extent of the interference between the seal lips and the inner race surface 12′ and the extent to which the seal lips will be deflected upon assembly of the seal 200 into the bearing 14′. As with the seal lips 102, 104 and 106 of the seal 100, the seal lips 202, 204 and 206 of the seal 200 has a length-to-width ratio which will give the material from which the seal is made sufficient stiffness such that the lip will not invert during use. Yet the resiliency of the seal lips will maintain seal contact with the inner race 12 as the inner and outer race move relative to each other or due to wear. Hence, the interference or deflection of the middle seal lip 204 is less than the in the interference or deflection of the inner and outer seal lips 206 and 202, respectively.

A seal's performance can be compromised if it is excessively distorted at installation. To reduce the amount of distortion of the seal during installation, the seal 200 includes an outboard diameter 210 and an inboard diameter 211 on opposite sides of the projection 209. As seen, the diameter of the inboard surface 211 is slightly less than the diameter of the outboard surface 210. By way of example, the difference in diameter can be as little as 0.010″-0.012″ (˜0.25 mm-˜0.30 mm). As shown schematically in FIG. 6, the outboard diameter 210 forms an interference fit with the outboard surface 10b′ of the bearing outer ring or bearing outer race 10′. The seal inboard surface 211, on the other hand, forms a clearance fit with the inboard surface 10c′ of the bearing outer race 14′. The inboard surface 211 aligns the seal 200 concentrically to the outer race or outer ring bore. This alignment feature minimizes distortion of the seal 200 when the seal OD to seal groove interference fit occurs. The seal surface 210 will also function as a retention member to prevent “roll-out” of the seal, as described above with the retention flange 110 of the seal 100.

Finally, the outboard seal face 212 is designed as a planar surface. At seal installation, the assembly of FIG. 6 is rotated 90° such that the seal face 212 is horizontal. The seal installation force is uniformly distributed over that surface, minimizing seal distortion during installation.

Preferably, the standardized envelope dimensions of the bearing assemblies 14 are not affected by the seal component 100, 200 of the present disclosure, so there is no decrease in the existing static or dynamic load ratings for standardized bearing assemblies 14. As various changes could be made in the above constructions without departing from the scope of the disclosure, it is intended that all matter contained in the above description or shown in the accompanying drawings shall be interpreted as illustrative and not in a limiting sense.

1. An annular seal component for sealing between an inner ring race surface and an outer ring race surface of a spherical bearing assembly, comprising:
an annular seal body, said annular seal body configured for retained placement between the inner ring race surface and outer ring race surface of the spherical bearing assembly;
first and second seal lips projecting from said annular seal body towards the inner ring race surface in a generally outwardly inclined orientation, said first and second seal lips contacting the inner ring race surface and configured to prevent contaminate ingress;
a third seal lip projecting from said annular seal body towards the inner ring race surface in an inwardly inclined orientation, said third seal lip contacting the inner ring race surface and configured to retain lubricant within the bearing assembly; and
wherein said first, second, and third seal lips each have an end surface curvature selected to minimize seal drag and to maximize seal contact against the inner ring race surface.

2. The annular seal component of claim 1 wherein said third seal lip is oriented to resist inversion.

3. The annular seal component of claim 1 wherein said third seal lip is has a length-to-width ratio selected to resist inversion during oscillatory motion across said inner ring race surface.

4. The annular seal component of claim 1 wherein said third seal lip contacts said inner race surface with an interference fit.

5. The annular seal component of claim 1 wherein said first and second seal lips are each oriented to have a contact angle selected to resist inversion.

6. The annular seal component of claim 1 wherein said first and second seal lips each have a length-to-width ratio selected to resist inversion during oscillatory motion across said inner ring race surface.

7. The annular seal component of claim 1 wherein said first and second seal lips each contact said inner ring race surface with an interference fit.

8. The annular seal component of claim 1 wherein each of said first, second, and third seal lips is dimensioned to obtain a material stiffness characteristic which resists inversion upon installation between the inner ring race surface and said outer ring race surface.

9. The annular seal component of claim 1 wherein said annular seal is configured for retained placement by a radial interference fit between an outer diameter of the annular seal body and a seal groove in the outer ring race surface.

10. The annular seal component of claim 9 wherein the annular seal includes an outboard surface which engages an outboard surface of said bearing outer race to prevent “roll-out” of the annular seal body during rotational movement between the inner ring race surface and the outer ring race surface.

11. The annular seal component of claim 10 wherein the outboard surface is an outer surface of an outwardly projecting retention flange configured for abutting contact with an outward surface of the outer ring.

12. The annular seal component of claim 11 wherein said retention flange has a generally rectangular cross-section; and
wherein said retention flange is disposed at an acute angle relative to said annular seal body.

13. The annular seal component of claim 12 wherein said retention flange is further disposed at an acute angle relative to said first seal lip.

14. The annular seal component of claim 10 including in inboard surface defining a diameter less than the diameter defined by said outboard surface; said inboard surface defining an alignment diameter and outboard surface defining a seal face that is used as an installation surface when the seal component is assembled into the bearing.

15. The annular seal component of claim 14 wherein said inboard surface and outboard surface are positioned on opposite sides of a projection, said projection being sized and shaped to be received in a retention groove of the bearing outer race.

16. The annular seal component of claim 9 wherein the annular seal body further includes a retention flange projecting outward from said annular seal body at an acute angle, said retention flange configured for abutting contact with an outward portion of the outer ring surface adjacent to said seal groove, said retention flange disposed to resist moment forces generated by seal drag friction forces between the seal lips and the inner ring race surface.

17. The annular seal component of claim 1 wherein said annular seal body is formed from a resilient homogeneous material.

18. A bearing assembly comprising:
an outer ring defining an outer race surface, and a retention groove formed in said outer race surface;
an inner ring defining an inner race surface; and
a seal received between said inner and outer race surfaces; said seal comprising
an annular seal body defining an outer diameter surface;
a projection extending from said annular seal body outer diameter surface to be received in said retention groove of said outer ring;
first and second seal lips projecting from said annular seal body towards the inner ring race surface in a generally outwardly inclined orientation, said first and second seal lips contacting the inner ring race surface with an interference fit and configured to prevent contaminate ingress; said first and second seal lips each have a length-to-width ratio selected to resist inversion during oscillatory motion across said inner ring race surface; and
a third seal lip projecting from said annular seal body towards the inner ring race surface in an inwardly inclined orientation, said third seal lip contacting the inner ring race surface and configured to retain lubricant within the bearing assembly; said third seal lip having a length-to-width ratio selected to resist inversion during oscillatory motion across said inner ring race surface.

19. The bearing assembly of claim 18 wherein the annular seal includes an outboard surface which engages an outboard surface of said bearing outer race to prevent “roll-out” of the annular seal body during rotational movement between the inner ring race surface and the outer ring race surface.

20. The bearing assembly of claim 19 wherein the outboard surface is an outer surface of an outwardly projecting retention flange; said outboard surface being in abutting contact with an outward surface of the outer ring.

21. The bearing assembly of claim 20 wherein said retention flange is disposed at an acute angle relative to said annular seal body.

22. The bearing assembly of claim 21 wherein said retention flange is further disposed at an acute angle relative to said first seal lip.

23. The bearing assembly of claim 19 including wherein said seal includes in inboard surface defining a diameter less than the diameter defined by said outboard surface; said inboard surface defining an alignment diameter and outboard surface defining a seal face that is used as an installation surface when the seal component is assembled into the bearing.

24. The bearing assembly of claim 23 wherein said inboard surface and outboard surface are positioned on opposite sides of said projection.
